(19) United States
(12) Patent Application Publication
(10) Pub. No.: US 2019/0325245 A1
(43) Pub. Date: Oct. 24, 2019

(54) INFORMATION PROCESSING APPARATUS AND NON-TRANSITORY COMPUTER READABLE MEDIUM STORING PROGRAM

(71) Applicant: FUJI XEROX CO., LTD., Tokyo (JP)

(72) Inventors: Junichi SHIMIZU, Kanagawa (JP); Akane ABE, Kanagawa (JP); Kazuhiro OYA, Kanagawa (JP); Kunihiko KOBAYASHI, Kanagawa (JP); Shigeru OKADA, Kanagawa (JP); Shintaro ADACHI, Kanagawa (JP); Akinobu YAMAGUCHI, Kanagawa (JP); Shinya NAKAMURA, Kanagawa (JP)

(73) Assignee: FUJI XEROX CO., LTD., Tokyo (JP)

(21) Appl. No.: 16/354,225

(22) Filed: Mar. 15, 2019

(30) Foreign Application Priority Data
Apr. 20, 2018 (JP) 2018-081778

(51) Int. Cl. G06K 9/32; G06K 9/00

(52) U.S. Cl. CPC G06K 9/3233; G06K 9/00463; G06K 9/3275

(57) ABSTRACT

An information processing apparatus includes an extraction unit that extracts object information from an image including an object to be read having a predetermined size; a cutting unit that cuts out a first area including at least a part of the object to be read from the image; and a changing unit that changes the first area such that an area having a background color different from a background color of the image is included, from the first area, when the first area cut out by the cutting unit has a size different from the predetermined size.

### CROSS-REFERENCE TO RELATED APPLICATIONS

This application is based on and claims priority under 35 USC 119 from Japanese Patent Application No. 2018-081778 filed Apr. 20, 2018.

### BACKGROUND

### (i) Technical Field

The present invention relates to an information processing apparatus and a non-transitory computer readable medium storing a program.

### (ii) Related Art

In recent years, there has been proposed an information processing apparatus which reads and images a small piece of paper such as a business card or a card (see, for example, JP2013-26839A).

The information processing apparatus described in JP2013-26839A includes a contour extraction unit that extracts contour lines of a figure in an image; a vertex extraction unit that sets a longest straight line constituting the contour lines extracted by the contour extraction unit as a ling side and extracts coordinates of each vertex of a rectangular area including all of the contour lines in the area; an image cutout unit that cuts out a rectangular image from the image based on the coordinates extracted by the vertex extraction unit; an upright correction unit that erects the rectangular image cut out by the image cutout unit; and a top-and-bottom determination unit that determines the top and bottom of the rectangular image erected by the upright correction unit and rotates the rectangular image in a forward direction according to the determination result.

### SUMMARY

Aspects of non-limiting embodiments of the present disclosure relate to an information processing apparatus which is capable of recognizing an object to be read even in a case where an area of a size different from the object to be read is cut out from an image of the object to be read, and a non-transitory computer readable medium storing a program.

Aspects of certain non-limiting embodiments of the present disclosure overcome the above disadvantages and other disadvantages not described above. However, aspects of the non-limiting embodiments are not required to overcome the disadvantages described above, and aspects of the non-limiting embodiments of the present disclosure may not overcome any of the problems described above.

According to an aspect of the present disclosure, there is provided an information processing apparatus including an extraction unit that extracts object information from an image including an object to be read having a predetermined size; a cutting unit that cuts out a first area including at least a part of the object to be read from the image; and a changing unit that changes the first area such that an area having a background color different from a background color of the image is included, from the first area, when the first area cut out by the cutting unit has a size different from the predetermined size.

### BRIEF DESCRIPTION OF THE DRAWINGS

Exemplary embodiment(s) of the present invention will be described in detail based on the following figures, wherein:

FIG. 1 is a diagram illustrating a configuration example of an information processing system according to a first exemplary embodiment of the present invention;

FIG. 2 is a block diagram showing an example of a control system of the information processing apparatus shown in FIG. 1;

FIGS. 3A to 3C are diagrams showing examples of a read image;

FIGS. 4A to 4H are diagrams showing examples of a candidate area;

FIG. 5 is a diagram showing an example of an area information table;

FIG. 6 is a flowchart showing an example of an operation of the information processing apparatus according to the first exemplary embodiment;

FIGS. 7A to 7C are diagrams showing examples of a read image;

FIG. 8 is a flowchart showing an example of an operation of an information processing apparatus according to a second exemplary embodiment of the present invention;

FIG. 9 is a diagram showing a modification example of a second rectangular area;

FIGS. 10A to 10H are diagrams showing examples of a candidate area;

FIG. 11 is a diagram showing examples of third and fourth rectangular areas;

FIG. 12 is a flowchart showing an example of an operation of an information processing apparatus according to a third exemplary embodiment of the present invention; and

FIGS. 13A and 13B are diagrams showing examples of a read image.

### DETAILED DESCRIPTION

Hereinafter, exemplary embodiments of the present invention will be described with reference to the drawings. In the drawings, the same reference numerals are attached to the constituent elements having substantially the same function, and duplicated explanations are omitted.

### Summary of Exemplary Embodiments

An information processing apparatus according to the present exemplary embodiments includes an extraction unit that extracts object information from an image including an object to be read having a predetermined size; a cutting unit that cuts out a first area including at least a part of the object to be read from the image; and a changing unit that, when the first area cut out by the cutting unit has a size different from the predetermined size, changes the first area such that an area having a background color different from the background color of the image is included, from the first area.

The information processing apparatus corresponds to, for example, an image forming apparatus such as a multifunction peripheral and a scanner, a personal computer, a multifunctional mobile phone (smartphone), or the like.

An object to be read is an object having a predetermined size. Examples of the object to be read include personal authentication media such as business cards, driver's licenses, employee ID cards, ID cards, and passports, transaction media such as credit cards, cash cards, and prepaid cards, and formal paper media such as forms of slips or the like and receipts. The object to be read has a rectangular shape, but it may have a square shape, or may have other polygonal shapes or a shape including a curve. Further, the object to be read includes those in which four corners are rounded.

“Object information” refers to information indicating characteristics of constituent elements constituting an object to be read. The object information includes, for example, text information, figure information, table information, and position information indicating positions thereof in the image.

“Changing the first area such that an area having a background color different from the background color of the image, from the first area” includes, for example, changing the first area (for example, expansion or reduction of the first area) such that the object information is included, with the first area as a base point, and changing the first area such that plural divided areas are included.

### First Exemplary Embodiment

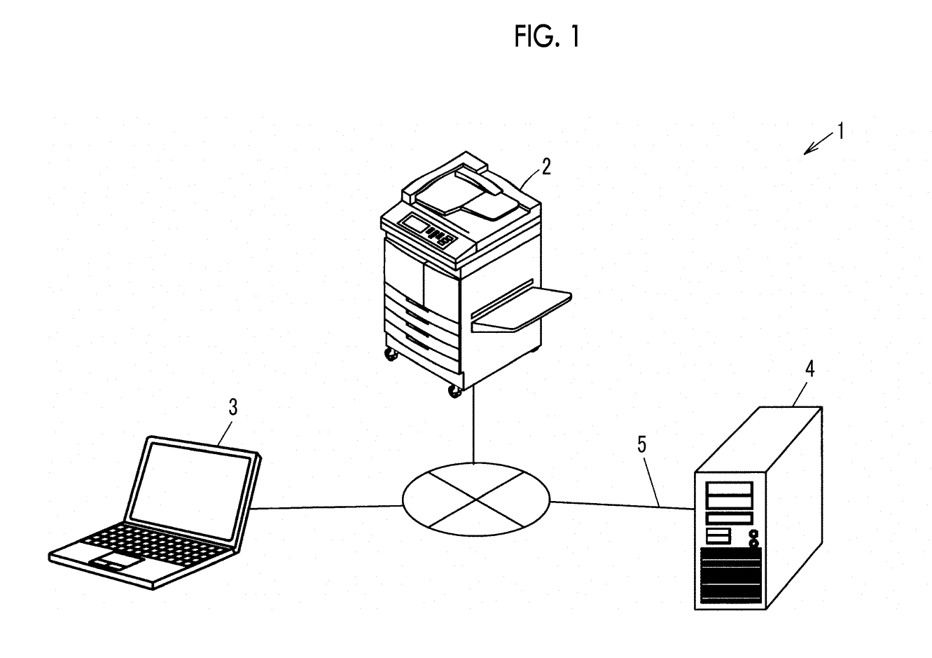

FIG. 1 is a diagram illustrating a configuration example of an information processing system according to a first exemplary embodiment of the present invention. As shown in FIG. 1, the information processing system 1 includes an information processing apparatus 2, a terminal device 3 and an external device 4 which are connected to the information processing apparatus 2 through the network 5.

As the terminal device 3, for example, a personal computer, a tablet type terminal, a multifunctional mobile phone (smartphone), or the like may be used. The external device 4 includes, for example, a personal computer, a server device, and the like. The network 5 is, for example, a local area network (LAN), a wide area network (WAN), the Internet, an intranet, or the like, and may be wired or wireless.

Configuration of Information Processing Apparatus 2

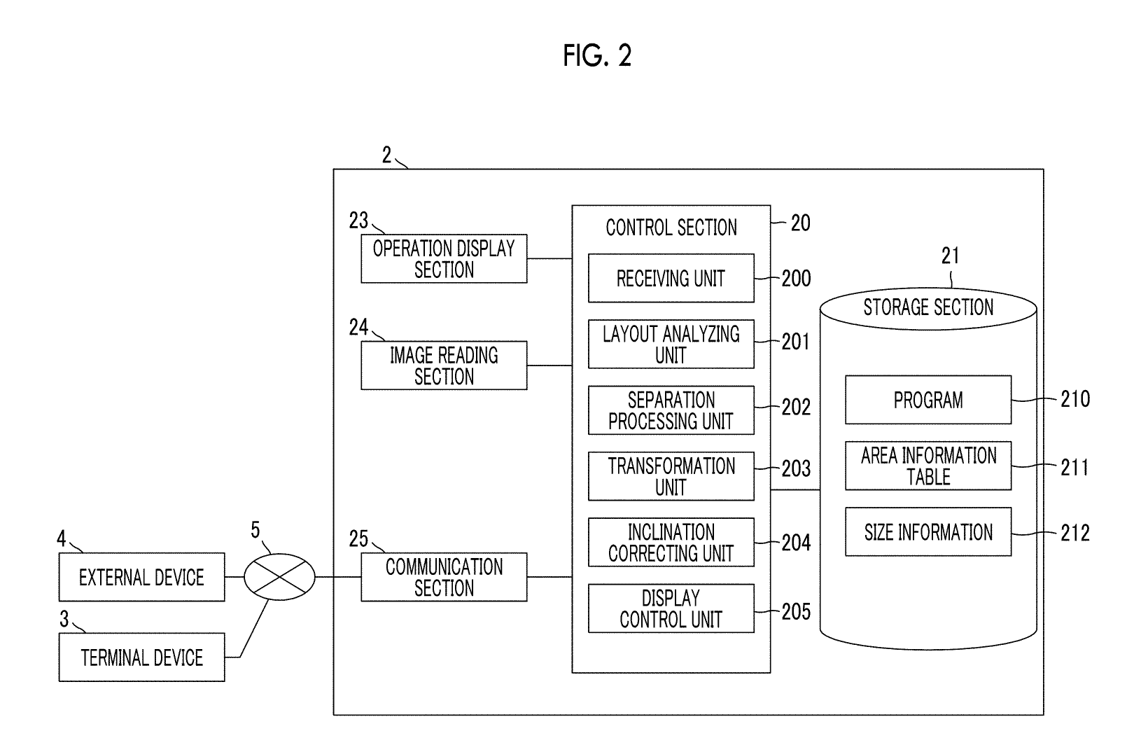

FIG. 2 is a block diagram showing an example of a control system of the information processing apparatus 2 shown in FIG. 1. Hereinafter, the image forming apparatus will be described as an example of the information processing apparatus 2, but the information processing apparatus 2 is not limited to the image forming apparatus. The information processing apparatus 2 includes a control section 20 that controls each unit, a storage section 21 that stores various types of data, an operation display section 23 that inputs and displays information, an image reading section 24 that reads an object to be read, and a communication section 25 that communicates with the terminal device 3 and the external device 4 through the network 5.

The control section 20 includes a central processing unit (CPU), an interface, and the like. By operating according to the program 210 stored in the storage section 21, the CPU functions as a receiving unit 200, a layout analyzing unit 201, a separation processing unit 202, a transformation unit 203, an inclination correcting unit 204, a display control unit 205, and the like. The transformation unit 203 is an example of a changing unit. The layout analyzing unit 201 is an example of an extraction unit. The separation processing unit 202 is an example of a cutting unit. Details of each of units 200 to 205 will be described later.

The storage section 21 includes a read only memory (ROM), a random access memory (RAM), a hard disk, and the like, and stores various data such as a program 210, an area information table 211, and size information 212. Details of the area information table 211 will be described later. The size information 212 is information indicating the size of an object to be read. The size of the object to be read is an example of a predetermined size.

The operation display section 23 is, for example, a touch panel display, and has a configuration in which a touch panel is overlapped and arranged on a display such as a liquid crystal display.

The image reading section 24 forms an image (hereinafter also referred to as “read image”) of an object to be read, which is obtained by optically reading the object to be read. The communication section 25 transmits and receives signals to and from the terminal device 3 and the external device 4 through the network 5.

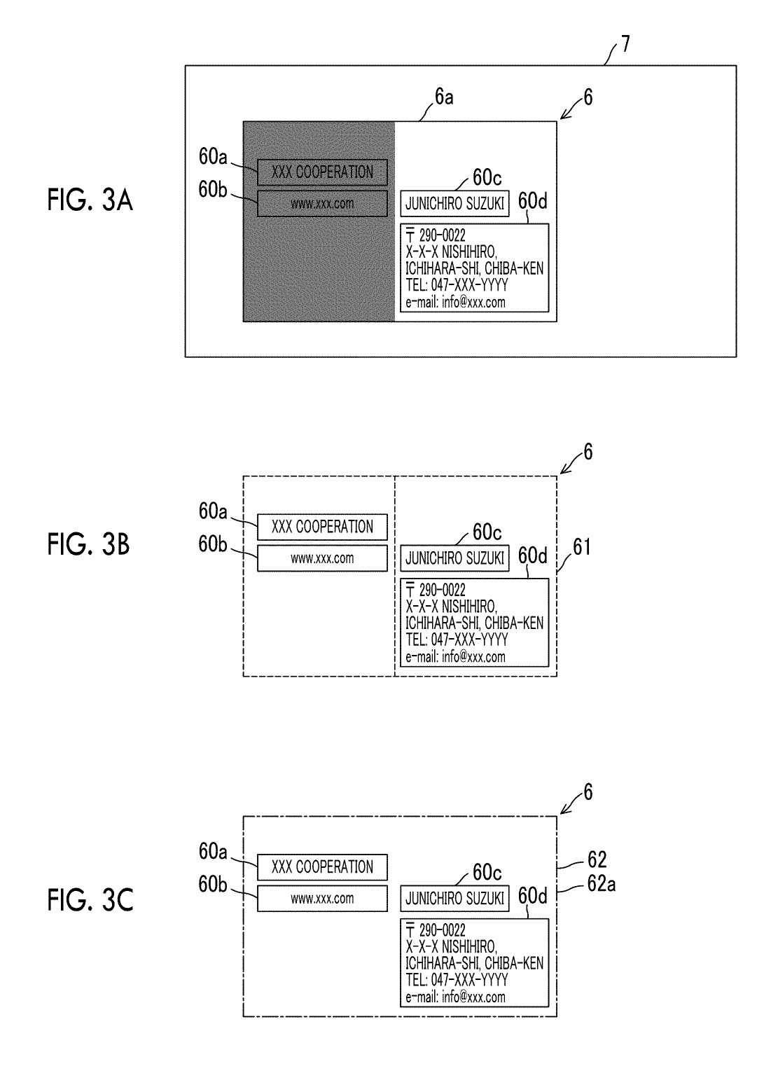

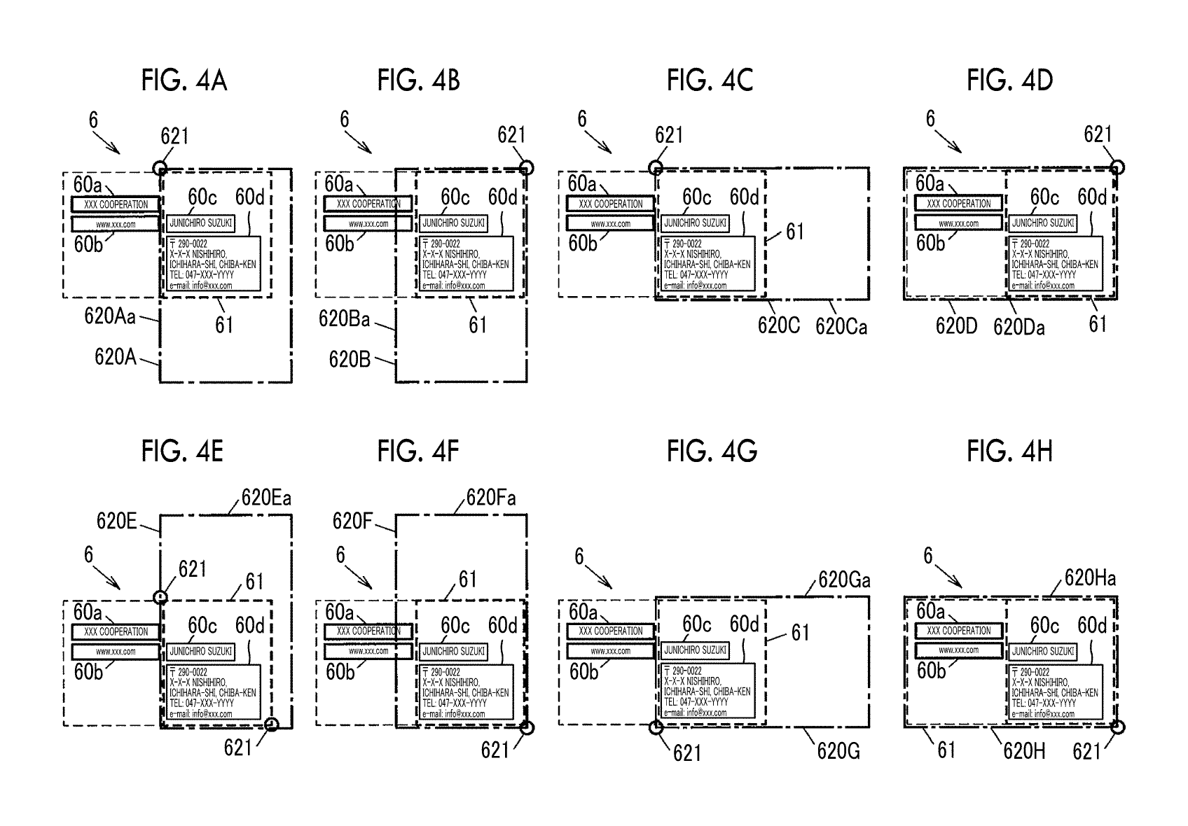

Next, details of each of sections 200 to 205 of the control section 20 will be described with reference to FIGS. 3A to 3C and 4. FIGS. 3A to 3C are diagrams showing examples of a read image. Hereinafter, as an object 6 to be read, a business card having a rectangular standard size will be described as an example. Further, a case where one object 6 to be read is included in the read image 7 will be described as an example. In addition, in FIGS. 3A to 3C, for convenience of explanation, the object 6 to be read is drawn largely with respect to the read image 7, but the relationship between the actual sizes of the read image 7 and the object 6 to be read is not limited to the examples shown in FIGS. 3A to 3C.

The receiving unit 200 receives the read image 7 read by the image reading section 24. The layout analyzing unit 201 extracts object information 60 indicating features of the object 6 to be read included in the read image 7 read by the receiving unit 200 (hereinafter also referred to as “layout analysis”). Here, the object information 60 refers to text information, figure information, table information, and position information indicating the positions of the text information and the figure information. The layout analysis includes, for example, text analysis for acquiring text information and the like included in the object 6 to be read by executing optical character recognition (OCR) on the read image 7, shape analysis for specifying the shapes of the constituent elements constituting the object 6 to be read, and the like.

The text information is information indicating the position of a text, in addition to the information indicating the attributes (size, text type, and the like) of the text. The text information includes, for example, affiliation information such as a company name and a department name, personal information such as a title, a position, and a name, contact information such as a phone number, a fax number, an e-mail address, and a company address, and the like.

The figure information refers to information indicating a figure itself, information indicating a designed one including a figure or a text, and information indicating the position thereof. The figure information includes, for example, a logo mark indicating a company name or a group name, a figure including a catch phrase or a slogan, a symbol mark indicating a registered qualification and a certified standard, a photograph or a portrait showing a possessor, or the like. In addition, information indicating the shape of the object 6 to be read itself is not included in the figure information. The table information refers to information indicating a table and information indicating its position.

FIG. 3A is a diagram showing an example of a read image 7 from which the object information 60 is extracted. As shown in FIG. 3A, for example, the layout analyzing unit 201 extracts affiliation information 60a as object information 60, URL information 60b indicating a URL, name information 60c indicating a name, address information 60d indicating a company address.

Further, the layout analyzing unit 201 stores the object information 60 extracted by analyzing the layout of the read image 7 and the position information of the area corresponding to the object information 60, in the area information table 211 of the storage section 21, in association with each other. The area corresponding to the object information 60 may be, for example, a rectangular area (see each square frame in FIG. 3A).

The separation processing unit 202 cuts out an area including at least a part of the object 6 to be read from the read image 7 received by the receiving unit 200.

Specifically, the separation processing unit 202 detects the edge of the object 6 to be read from the read image 7 and performs a process of extracting the contour line 6a of the object 6 to be read (hereinafter also referred to as “edge emphasis process”). Further, the separation processing unit 202 performs a labeling process of assigning a number (not shown) to the object 6 to be read, based on the extracted contour line 6a of the object 6 to be read. Further, the separation processing unit 202 performs a cutting process for cutting out an area based on the result of the labeling process. Known algorithms may be used for these edge emphasis process, labeling process, and cutting process. In the following description, a case where the separation processing unit 202 cuts out a rectangular area 61 (hereinafter also referred to as “first rectangular area 61”) having at least one vertex among the vertices of the read image 7 according to the shape of the object 6 to be read will be described as an example. The first rectangular area 61 is an example of the first area.

FIG. 3B is an enlarged view of FIG. 3A, which schematically shows an example of the first rectangular area 61. As shown in FIG. 3B, the separation processing unit 202 cuts out the first rectangular area 61 (see a thick dashed line frame in FIG. 3B) from the read image 7. In the example shown in FIG. 3B, the first rectangular area 61 has a size smaller than the size of the object 6 to be read. Therefore, a part of the object 6 to be read is out of the first rectangular area 61. That is, the first rectangular area 61 includes only a part of the object 6 to be read. Note that the thin dashed line frame in FIG. 3B shows the outer edge of the object 6 to be read (corresponding to 6a in FIG. 3A).

The transformation unit 203 obtains the size of the first rectangular area 61 cut out by the separation processing unit 202, obtains the size of the object 6 to be read from the size information 212 of the storage section 21, and compares the size of the first rectangular area 61 with the size of the object 6 to be read. In a case where the size of the first rectangular area 61 is different from the size of the object 6 to be read, the transformation unit 203 transforms the first rectangular area 61 into the rectangular area 62 (hereinafter also referred to as “second rectangular area 62”) such that the object information 60 extracted by the layout analyzing unit 201 is included, with the first rectangular area 62 as a base point. The second rectangular area 62 is an example of an expanded area expanded, with the first area as a base point.

In addition, “the size is different” means that the difference between the size of the first rectangular area 61 and the size of the object 6 to be read is equal to or greater than a predetermined specific value, and does not mean that “the sizes are not exactly the same”. In addition, “sizes are not different” does not mean that “the sizes are exactly the same”.

Preferably, for example, the second rectangular area 62 has substantially the same size as the size of the object 6 to be read. By doing so, a part of the object 6 to be read which is not cut out by the separation processing unit 202 but is out of the first rectangular area 61 is covered by the second rectangular area 62. In addition, substantially the same size is not limited to “exactly the same size” but includes, for example, a case where the number of pixels corresponding to the pair area differs only by a few.

Specifically, when the size of the first rectangular area 61 is smaller than the size of the object 6 to be read, the transformation unit 203 expands the first rectangular area 61 to the second rectangular area 62 having substantially the same size as that of the object 6 to be read so as to include the object information 60. In addition, “smaller than the size” means that the difference between the size of the first rectangular area 61 and the size of the object 6 to be read is equal to or greater than a predetermined specific value, and does not mean that the difference between the size of the first rectangular area 61 and the size of the object 6 to be read is less than a specific minute value.

FIG. 3C is an enlarged view of FIG. 3A, which schematically shows an example of the second rectangular area 62. As shown in FIG. 3C, for example, when the size of the first rectangular area 61 is smaller than the size of the object 6 to be read (see FIG. 3B), the transformation unit 203 expands the first rectangular area 61 to the second rectangular area 62 (see the dot-dashed line frame in FIG. 3C).

Further, the transformation unit 203 expands the first rectangular area 61 to the second rectangular area 62 such that the object information 60 is not divided by the edge portion 62a of the second rectangular area 62 and the extracted object information 60 is included without excess or deficiency. As one example, the transformation unit 203 selects and sets a specific candidate area from at least one rectangular area (hereinafter also referred to as “candidate areas”) which are candidates for the second rectangular area 62 as the second rectangular area 62, and expands the first rectangular area 61 to the selected second rectangular area 62.

FIGS. 4A to 4H are diagrams showing examples of a candidate area. Specifically, as shown in FIGS. 4A to 4H, the transformation unit 203 prepares eight candidate areas 620A to 620H (see the dot-dashed line frame in each of FIGS. 4A to 4H) surround to include the first rectangular area 61, with any one vertex of four vertices of the first rectangular area 61 as one reference point 621, as candidates for the second rectangular area 62, selects and sets one candidate area which does not divide the object information 60 and includes the object information 60 without excess or deficiency, from among the eight candidate areas 620A to 620H, as the second rectangular area 62, and expands the first rectangular area 61 to the selected second rectangular area 62. That is, the transformation unit 203 transforms the first rectangular area into the second rectangular area 62, with the first rectangular area 61 as a base point.

In addition, the changing unit not only expands or reduces the first area including at least a part of the object to be read, which is read by the image reading section, but also changes the vertex of the first area.

In the example of each of FIGS. 4A to 4H, the candidate area 620A in FIG. 4A, the candidate area 620C in FIG. 4C, the candidate area 620F in FIG. 4F, and the candidate area 620G in FIG. 4G are examples where some of the object information 60 is not included. Further, candidate area 620B in FIG. 4B and the candidate area 620E in FIG. 4E are examples in the case where the object information 60 is divided by the edge portions 620Ba, 620Ea of the candidate areas 620B, 620E. The candidate area 620D in FIG. 4D and the candidate area 620H in FIG. 4H are examples of the case where the object information 60 is not divided and all the object information 60 is included. The transformation unit 203 selects the candidate area 620D in FIG. 4D or the candidate area 620H in FIG. 4H as the second rectangular area 62.

In FIGS. 4A to 4H, the thick dashed line frames show the first rectangular area 61, and the thin dashed line frames show the outer edge of the object 6 to be read. For convenience of explanation, some sides of the dot-dashed line frame showing the second rectangular area 62 are drawn so as to be located outside the thick dashed line frame showing the first rectangular area 61, but an actual dot-dashed line frame may overlap the thick dashed line frame.

In addition, the transformation unit 203 collates the position information of the object information 60 recorded in the area information table 211 with the position information of the candidate areas 620A to 620H and determines whether or not the edge portions 620Aa to 620Ha of the candidate areas 620A to 620H do not divide the object information 60 and whether or not all of the extracted object information 60 is included in any of the candidate areas 620A to 620H.

The inclination correcting unit 204 obtains the amount (hereinafter also referred to as “skew amount”) indicating the degree of the inclination of the first rectangular area 61 or the second rectangular area 62, and corrects the inclination of the first rectangular area 61 or the second rectangular area 62 by rotating the first rectangular area 61 or the second rectangular area 62 based on the amount of skew (hereinafter referred to as “skew correction”).

The display control unit 205 controls so as to display a screen including the read image 7, the first rectangular area 61, the second rectangular area 62, and the like on the display surface (not shown) of the operation display section 23.

Configuration of Area Information Table 211

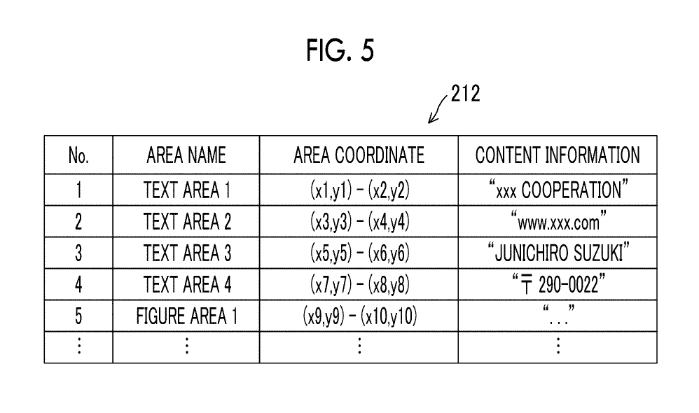

FIG. 5 is a diagram showing an example of the area information table 211. In the area information table 211, position information indicating the position of an area corresponding to the object information 60 extracted from the read image 7 (hereinafter also simply referred to as “area”) and text information and figure information included in each area are stored in association with each other. In the area information table 211, for example, an “area name” column, an “area coordinate” column, and a “content information” column are provided.

In the “area name” column, the name of the extracted area is recorded. In the “area coordinate” column, for example, the coordinates of the upper left vertex and the lower right vertex of the area are recorded as the coordinates indicating the area. In the “area coordinate” column, the coordinate value of a specific vertex of the area and the height and width of the area may be described as the position information of the area. In the “content information” column, text information or figure information included in the area is recorded. In the present specification, “recording” is used in a case where information is written into a table, and “storage” is used in a case where information is written into the storage section 21.

Operation of First Exemplary Embodiment

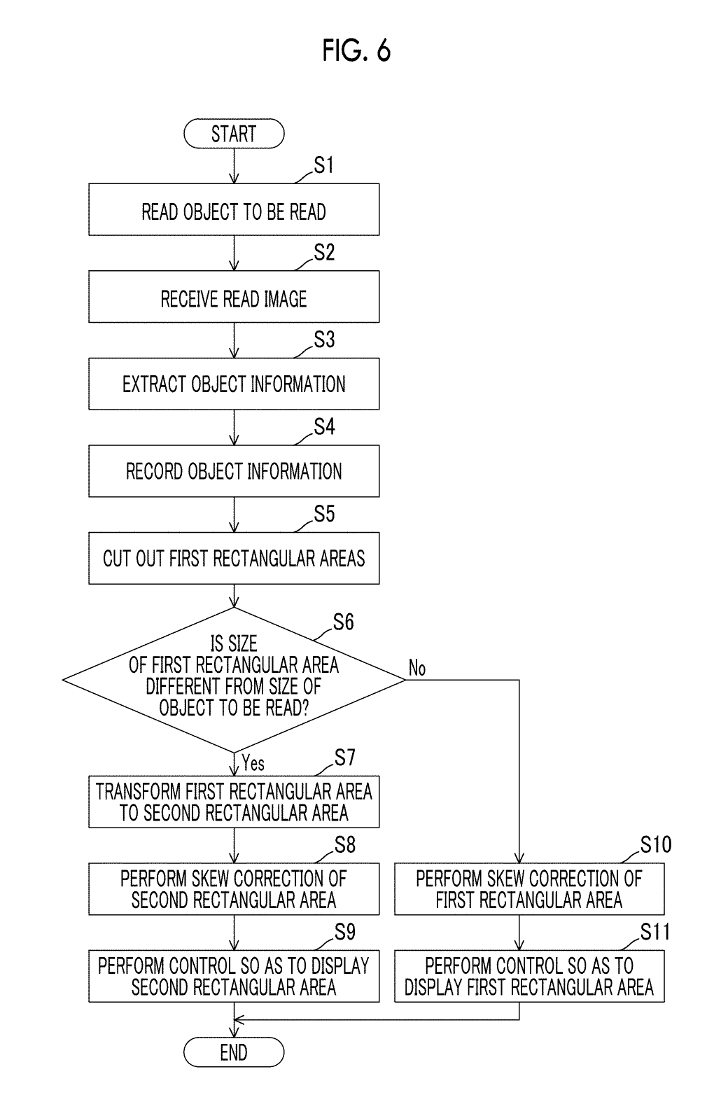

Next, an example of the operation of the information processing apparatus 2 will be described with reference to FIGS. 3A to 3C and FIG. 6. FIG. 6 is a flowchart illustrating an example of the operation of the information processing apparatus 2. The image reading section 24 reads the object 6 to be read (S1), and as illustrated in FIGS. 3A to 3C, forms the read image 7 and transfers the read image 7 to the receiving unit 200 of the control section 20.

The receiving unit 200 receives the read image 7 read by the image reading section 24 (S2). Next, as shown in FIG. 3A, the layout analyzing unit 201 extracts the object information 60 of the object 6 to be read included in the read image 7 (S3). Further, the layout analyzing unit 201 stores the extracted object information 60 and the position information of the area corresponding to the object information 60, in the area information table 211 of the storage section 21, in association with each other (S4).

Next, as shown in FIG. 3B, the separation processing unit 202 performs an edge emphasis process, a labeling process, a cutting process, and the like on the read image 7 to generate a first rectangular area 61 including at least a part of the object 6 to be read (S5).

Next, the transformation unit 203 obtains the size of the first rectangular area 61 cut out by the separation processing unit 202, obtains the size of the object 6 to be read from the size information 212 stored in the storage section 21, and compares the size of the first rectangular area 61 with the size of the object 6 to be read (S6).

In a case where the size of the first rectangular area 61 is different from the size of the object 6 to be read (S6: Yes), as illustrated in FIG. 3C, the transformation unit 203 transforms the first rectangular area 61 into the second rectangular area 62 such that the object information 60 is not divided and all the object information 60 is included (S7). Specifically, in a case where the size of the first rectangular area 61 is smaller than the size of the object 6 to be read, as illustrated in FIG. 3C, the transformation unit 203 expands the first rectangular area 61 to the second rectangular area 62.

The inclination correcting unit 204 performs skew correction of the second rectangular area 62 (S8). The display control unit 205 controls to display the second rectangular area 62 after skew correction on the display surface of the operation display section 23 (S9).

In a case where the size of the first rectangular area 61 is not different from the size of the object 6 to be read (S6: Yes), the inclination correcting unit 204 performs skew correction of the first rectangular area 61 (S10). The display control unit 205 controls to display the first rectangular area 61 after skew correction on the display surface of the operation display section 23 (S11).

As described above, for example, even in the case where an area smaller than the size of the object 6 to be read from the read image 7 is cut out because a part of the object 6 to be read is colored with a dark color with respect to other parts of the object 6 to be read, it is possible to cut out and recognize the entirety of the object 6 to be read.

### Second Exemplary Embodiment

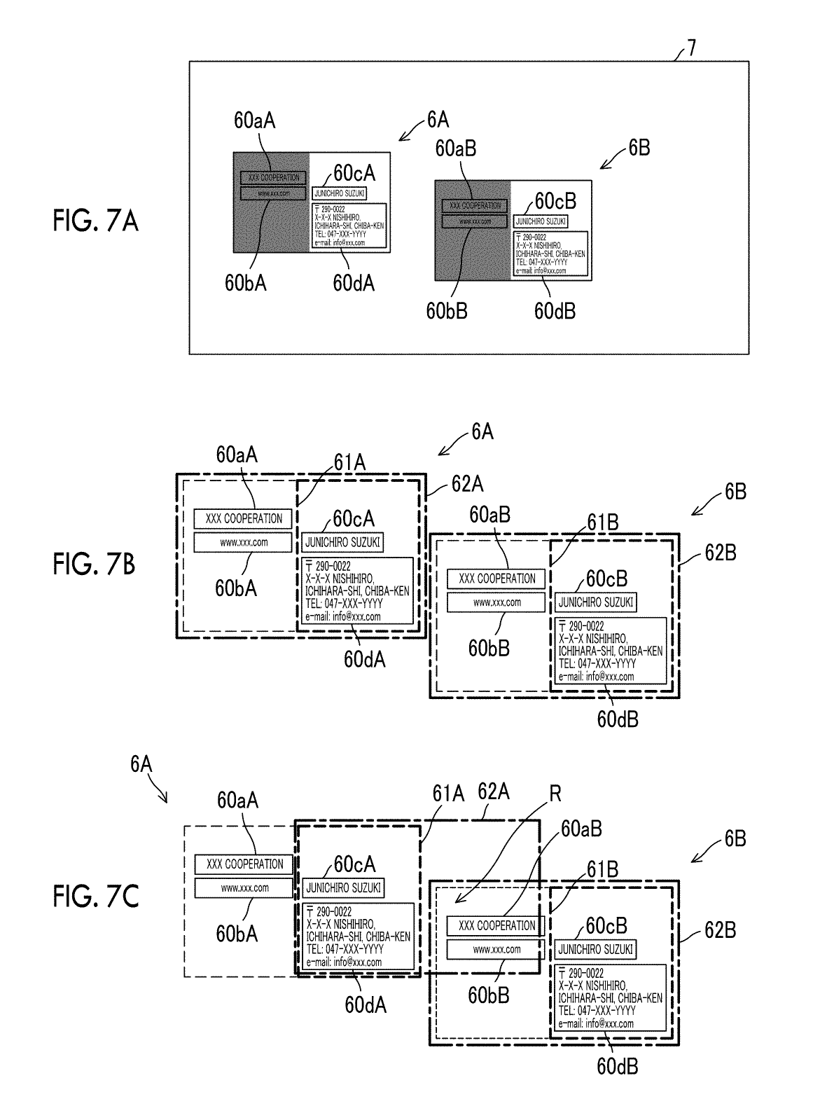

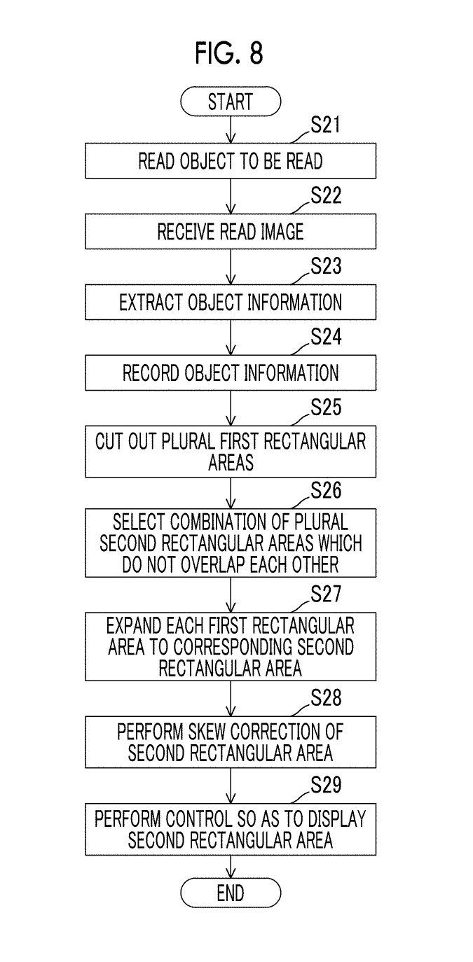

A second exemplary embodiment will be described with reference to FIGS. 7A to 7C and 8. FIGS. 7A to 7C are diagrams showing examples of the read image 7. The second exemplary embodiment is different from the first exemplary embodiment in that the transformation unit 203 has a function of selecting the second rectangular area 62 such that areas obtained by expanding the first rectangular area 61 do not overlap each other, in addition to the function described in the first exemplary embodiment. Hereinafter, configurations having substantially the same functions as those of the first exemplary embodiment will be denoted by the same reference numerals, the duplicated explanation will be omitted, and the differences from the first exemplary embodiment will be described. Further, a case where plural objects 6 to be read are included in the read image 7 will be described as an example.

FIG. 7A is a diagram showing an example of a read image 7 including plural objects 6 to be read. As shown in FIG. 7A, the layout analyzing unit 201 extracts object information 60aA to 60dB (hereinafter collectively and simply referred to as “object information 60”) of the plural objects 6 to be read. In a case where plural objects 6 to be read are included in the read image 7, the separation processing unit 202 cuts out plural first rectangular areas 61 according to respective objects 6 to be read.

Further, the transformation unit 203 transforms the first rectangular area 61 having a size different from the size of the object 6 to be read, among the plural first rectangular areas 61 cut out by the separation processing unit 202, into the second rectangular area 62, as described in the first exemplary embodiment. At this time, in a case where some of the plural first rectangular areas 61, out of the plural first rectangular areas 61 cut out by the separation processing unit 202, have sizes different from the size of the object 6 to be read, the transformation unit 203 selects the combination of the second rectangular areas 62 in which areas respectively expanded from the some of the plural first rectangular areas 61 having sizes different from the size of the object 6 to be read do not overlap each other, and expands the some of the plural first rectangular areas 61 to the corresponding second rectangular areas 62, respectively. Here, “an area expanded from the first rectangular area 61” means an area obtained by excluding the area before expansion (that is, first rectangular area 61) from the area after expansion (that is, the second rectangular area 62).

In order to prevent the areas expanded from the first rectangular area 61 from overlapping each other, as an example, the transformation unit 203 may select a combination of the plural second rectangular areas 62 such that the object information 60 located in a specific direction with respect to the position of the first rectangular area 61 in the read image 7 is included, and expand the plural first rectangular areas 61 to the corresponding second rectangular areas 62, respectively.

Specifically, the transformation unit 203 selects candidate areas 620A to 620H such that the extracted plural pieces of object information 60 in the read image 7 having the values of the coordinates smaller than the values of the coordinates of the first rectangular area 61 are included, from among the above-described candidate areas 620A to 620H (see FIGS. 4A to 4H), and sets them as the second rectangular areas 62. Here, for “coordinates in the read image 7 of the object information 60”, for example, specific coordinates of interest (for example, the coordinates of the upper left vertex) in the area corresponding to the object information 60, that is, a rectangular area surrounding the extracted object information 60 maybe used. In addition, the upper left corner of the read image 7 may be the origin.

Further, a case where two objects 6 to be read are included in the read image 7 will be described more specifically as an example. The transformation unit 203 expands the primary first rectangular area 61 to the primary second rectangular area 62 such that a series of pieces of object information 60 having small coordinate values among the plural pieces of extracted object information 60 are included, and expands the secondary first rectangular area 61 to the secondary second rectangular area 62 such that the remaining pieces of object information 60 are included. In the case where there are three or more objects 6 to be read, the transformation unit 203 performs the above-described process on the plural first rectangular areas 61, and expands the first rectangular areas to the corresponding second rectangular areas 62, respectively. In addition, the “series of object information 60” means a group of pieces of object information 60 collected and located in a specific range.

FIG. 7B is an enlarged view of FIG. 7A, which schematically shows an example of the second rectangular area. More specifically, as shown in FIG. 7B, the transformation unit 203 expands the primary first rectangular area 61A, which is cut out from the first object 6A to be read located relatively on the left side in FIG. 7B, to the primary second rectangular area 62A including a series of pieces of object information 60aA, 60bA located on the left side of the first rectangular area 61A in FIG. 7B, and expands the secondary first rectangular area 61B, which is cut out from the second object 6B to be read located on the right side of the first object 6A to be read in FIG. 7B, to the secondary second rectangular area 62B including remaining series of object information 60aB, 60bB.

In FIGS. 7A and 7B, the thick dashed line frame shows the first rectangular area 61, and the thin dashed line frame shows the outer edge of the object 6 to be read. For convenience of explanation, each side of the dot-dashed line frame showing the second rectangular area 62 is drawn so as to be located outside the thick dashed line frame showing the first rectangular area 61 and the thin dashed line frame showing the outer edge of the object 6 to be read, but an actual dot-dashed line frame may overlap the thick dashed line frame and the thin dashed line frame.

The transformation unit 203 may determine the position of the area corresponding to the object information 60 in the read image 7, based on the position information recorded in the area information table 211 of the storage section 21. The separation processing unit 202 may determine whether one object 6 to be read is included or plural objects 6 to be read are included in the read image 7, according to the number of the first rectangular areas 61 which are cut out.

In the above example, the case is described as an example where some of the plural first rectangular areas 61, out of the plural first rectangular areas 61 cut out by the separation processing unit 202, have sizes different from the size of the object 6 to be read, but there may be a case where only one first rectangular area 61, among the plural first rectangular areas 61 cut out by the separation processing unit 202, has a size different from the size of the object 6 to be read. In this case, as described in the first exemplary embodiment, the transformation unit 203 expands the one first rectangular area 61 to the second rectangular area 62. In a case where the plural first rectangular areas 61 cut out by the separation processing unit 202 do not have ones having sizes different from the size of the object 6 to be read, the transformation unit 203 does not perform a transformation process on any of the first rectangular areas 61.

As a reference example, a case where plural second rectangular areas 62 overlap each other will be described. FIG. 7C shows an example in which the areas of the second rectangular areas 62A, 62B, expanded from the first rectangular areas 61A, 61B, overlap each other (see reference symbol “R” in FIG. 7C). The transformation unit 203 may determine whether or not the plural second rectangular areas 62A, 62B overlap each other, based on the position information of the second rectangular areas 62A, 62B.

Operation of Second Exemplary Embodiment

FIG. 8 is a flowchart showing an example of an operation of an information processing apparatus 2 according to a second exemplary embodiment of the present invention. The information processing apparatus 2 operates in steps S21 to S24 in the same manner as in steps S1 to S4 of the first exemplary embodiment. That is, the image reading section 24 reads the object 6 to be read (S21), the receiving unit 200 receives a read image 7 (S22), the layout analyzing unit 201 extracts the object information 60 of the object 6 to be read included in the read image 7 (S23) and stores the extracted object information 60 in the area information table 211 of the storage section 21 in association with the position information of the area corresponding to the object information 60 (S24).

Next, the separation processing unit 202 cuts out plural first rectangular areas 61 according to each object 6 to be read (S25). In a case where some of the plural first rectangular areas 61, out of the plural first rectangular areas 61 which are cut out, have sizes smaller than the size of the object 6 to be read, the transformation unit 203 selects a combination of the second rectangular areas 62 in which the areas respectively expanded from the some of the plural first rectangular areas 61 do not overlap each other (S26). Further, the transformation unit 203 expands each first rectangular area 61 to the corresponding second rectangular area 62 (S27). The operation of comparing the size of the first rectangular area 61 with the size of the object 6 to be read, performed by the transformation unit 203 during steps S25 and S26, is the same as in the first embodiment, and the detailed explanation thereof will be omitted.

Next, the inclination correcting unit 204 performs the skew correction of the second rectangular area 62 (S28), and the display control unit 205 performs control so as to display the second rectangular area 62 after skew correction on the display surface of the operation display section 23 (S29). In a case where among plural first rectangular areas 61 which are cut out, there are those having a size smaller than the size of the object 6 to be read and those having substantially the same size as the size of the object 6 to be read, the inclination correcting unit 204 performs skew correction of a first rectangular area 61 having a size smaller than the size of the object 6 to be read and a second rectangular area 62 obtained by expanding the first rectangular area 61 having a size smaller than the size of the object 6 to be read, respectively. The display control unit 205 performs controls so as to display the first rectangular area 61 and the expanded second rectangular area 62 on the display surface of the operation display section 23, respectively.

As described above, even in a case where an area having a size smaller than the size of the object to be read is cut out from the read image in the case where plural objects 6 to be read are included in the read image 7, the respective objects 6 to be read may individually be cut out and recognized.

### Modification Example

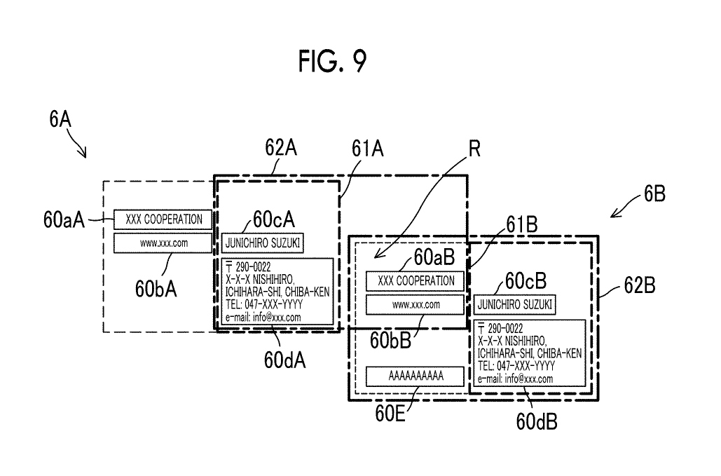

FIG. 9 is a diagram showing a modification example of the second rectangular area 62. In a case where plural objects 6 to be read are read in a state where they are overlapped, the transformation unit 203 may determine which object 6 to be read is on the front surface, that is, which object 6 to be read the object information 60 belongs to, based on the position information of specific object information 60e. Specifically, as shown in FIG. 8, when there is specific object information 60e included only in any one second rectangular area 62 out of two second rectangular areas 62A, 62B, the transformation unit 203 may determine that the object information 60 is included in the second object 6B to be read corresponding to the one second rectangular area 62B, that is, the second object 6B to be read corresponding to the one second rectangular area 62B is located on the front side in the read image 7 than the first object 6A to be read corresponding to the other second rectangular area 62A.

In FIG. 9, the thick dashed line frames show the first rectangular area 61, and the thin dashed line frames show the outer edge of the object 6 to be read. For convenience of explanation, some sides of the dot-dashed line frame showing the second rectangular areas 62A, 62B is drawn so as to be located outside the thick dashed line frame showing the first rectangular area 61 and the thin dashed line frame showing the outer edge of the object 6 to be read, but an actual dot-dashed line frame may overlap the thick dashed line frame and the thin dashed line frame.

### Third Exemplary Embodiment

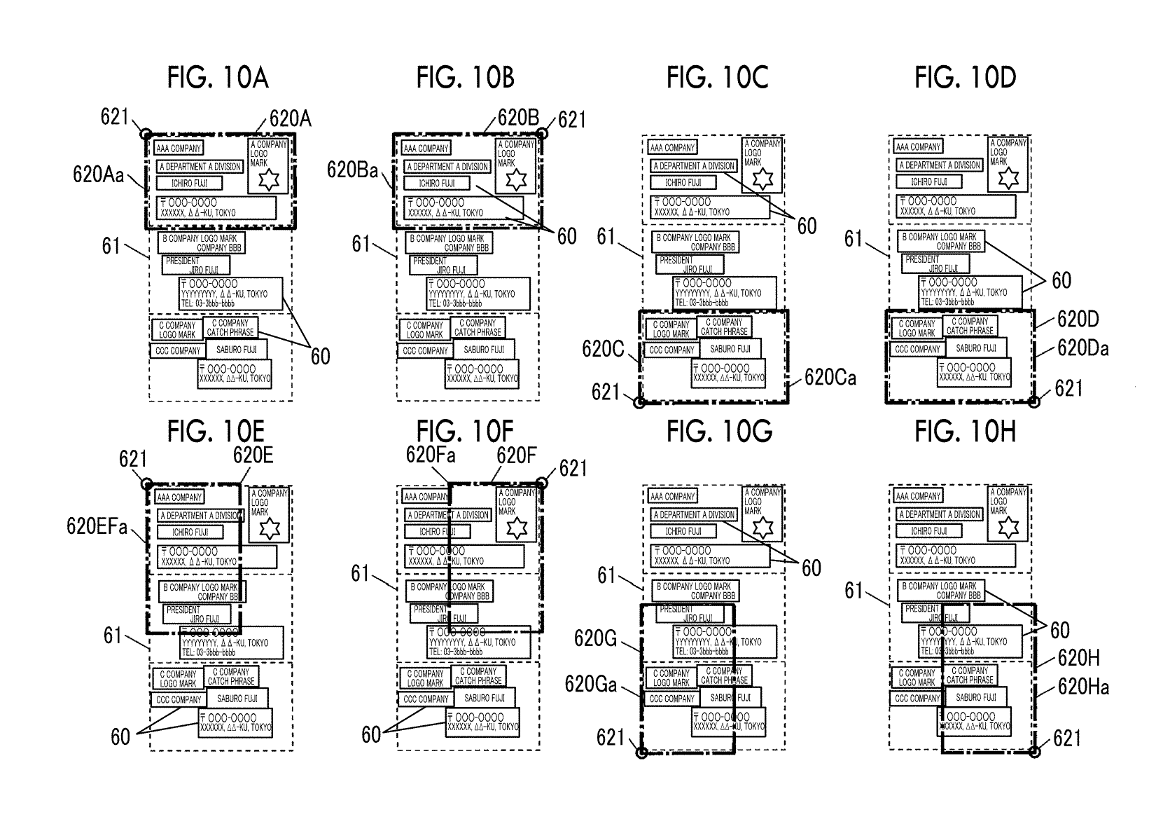

A third exemplary embodiment will be described with reference to FIGS. 10A to 12. The third exemplary embodiment is different from the first exemplary embodiment in that the transformation unit 203 has a function of reducing the first area to the second area such that the object information 60 is included, with the first area as a reference, in a case where the first area has a size larger than the size of the object 6 to be read.

Hereinafter, configurations having substantially the same functions as those of the first exemplary embodiment will be denoted by the same reference numerals, the duplicated explanation will be omitted, and the differences from the first exemplary embodiment will be described. In the following description, as an example, a case will be described where the size of the cut-out first rectangular area 61 is larger than the size of the object 6 to be read, that is, plural objects 6 to be read are included in the cut-out first rectangular area 61. For the sake of convenience of explanation, as an example, a case where three objects 6 to be read are included in the read image 7 is taken as an example. The second rectangular area 62 is an example of the second area.

In a case where the size of the first rectangular area 61 is larger than the size of the object 6 to be read, the transformation unit 203 reduces the first rectangular area 61 to the second rectangular area 62 such that the object information 60 is included, with the first rectangular area 61 as a base point. In addition, “larger than the size” means that the difference between the size of the first rectangular area 61 and the size of the object 6 to be read is equal to or greater than a predetermined specific value, and does not mean that the difference between the size of the first rectangular area 61 and the size of the object 6 to be read is less than a specific minute value.

FIGS. 10A to 10H are diagrams showing examples of candidate areas 620A to 620H. As shown in FIGS. 10A to 10H, the transformation unit 203 prepares eight candidate areas 620A to 620H surrounded to include at least a part of the extracted object information 60, with any one vertex of four vertices of the first rectangular area 61 as one reference point 621, as candidates for the second rectangular area 62, selects and sets candidate areas which does not divide the object information 60 and include the object information 60, from among the eight candidate areas 620A to 620H, as the second rectangular area 62, and reduces the first rectangular area 61 to the selected second rectangular area 62.

In the example of each of FIGS. 10A to 10H, the candidate area 620A in FIG. 10A, the candidate area 620B in FIG. 10B, the candidate area 620C in FIG. 10C, and the candidate area 620D in FIG. 10D are examples of a case where the object information 60 is not divided and the object information 60 is included. In contrast, the candidate area 620E in FIG. 10E, the candidate area 620F in FIG. 10F, the candidate area 620G in FIG. 10G, and the candidate area 620H in FIG. 10H are examples of a case where some of the object information 60 is divided by the edge portions 620Ea, 620Fa, 620Ga, 620Ha of the candidate areas 620E, 620F, 620G, 620H. The transformation unit 203 selects and sets the candidate area 620A in FIG. 10A, the candidate area 620B in FIG. 10B, the candidate area 620C in FIG. 10C, and the candidate area 620D in FIG. 10D as the second rectangular area 62, and reduces the first rectangular area 61 to the second rectangular area 62.

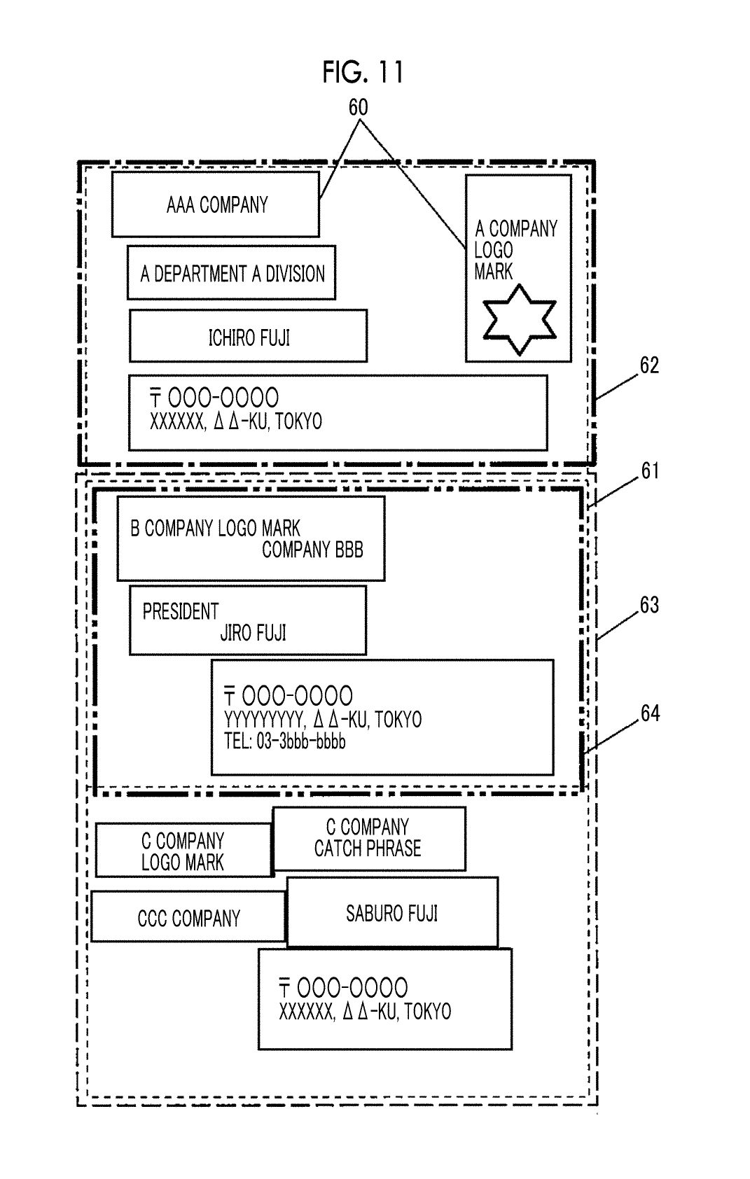

FIG. 11 is a diagram showing examples of third and fourth rectangular areas. FIG. 11 is a diagram corresponding to the case shown in FIG. 10A. The transformation unit 203 obtains the size of the third rectangular area 63 (see the long dashed-line frame in FIG. 11) obtained by excluding the second rectangular area 62 (see the dot-dashed line frame in FIG. 11) from the first rectangular area 61 before reduction (see the thin dashed line frame in FIG. 11), acquires the size of the object 6 to be read from the size information 212 of the storage section 21, and compares the size of the third rectangular area 63 with the size of the object 6 to be read. The third rectangular area 63 is an example of the third area.

Further, in a case where the size of the third rectangular area 63 is larger than the size of the object 6 to be read, the transformation unit 203 further reduces the third rectangular area 63 to the fourth rectangular area 64 (see the dot-dot-dashed line frame in FIG. 11). The fourth rectangular area 64 is an example of the fourth area. Since the process of reducing the third rectangular area 63 to the fourth rectangular area 64 is the same as the process of reducing the first rectangular area 61 to the second rectangular area 62, the detailed description thereof will be omitted.

In FIG. 11, for convenience of explanation, the respective frames are drawn so as not to overlap each other, but in reality, the respective frames overlap each other on both sides of the first rectangular area 61 in FIG. 11.

Operation of Third Exemplary Embodiment

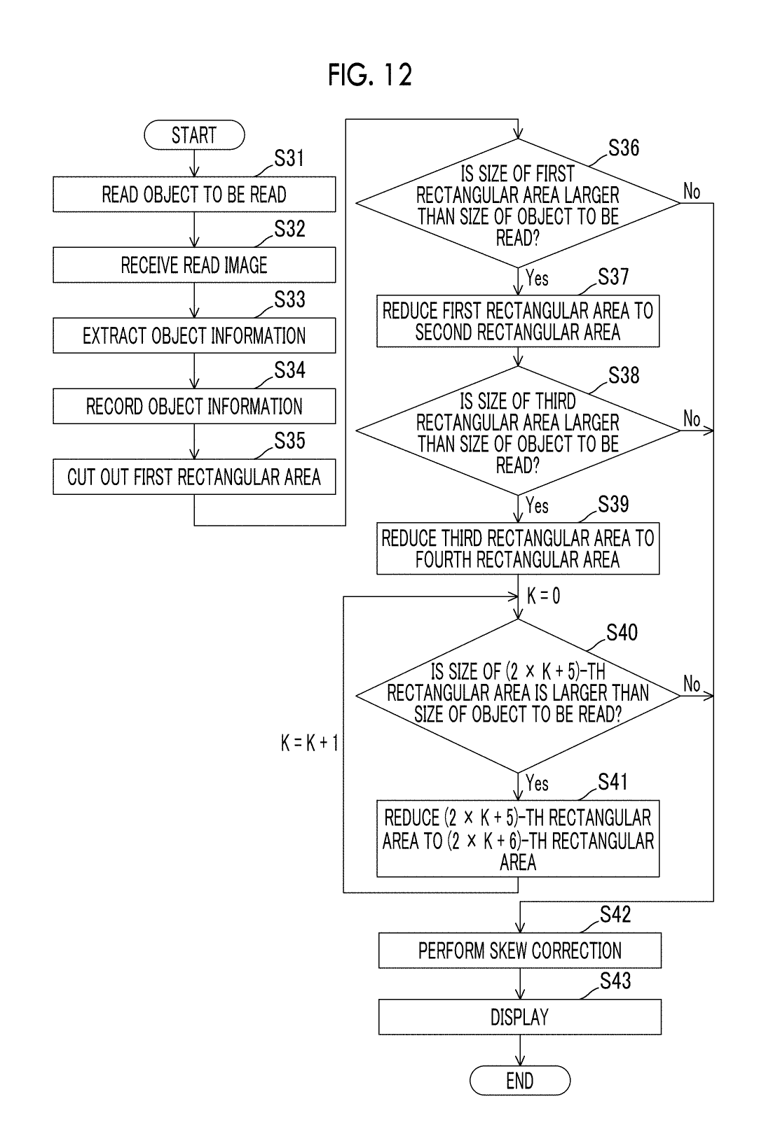

FIG. 12 is a flowchart showing an example of an operation of an information processing apparatus 2 according to a third exemplary embodiment of the present invention. The information processing apparatus 2 operates in steps S31 to S35 in the same manner as insteps S1 to S4 of the first exemplary embodiment. That is, the image reading section 24 reads the object 6 to be read (S31), the receiving unit 200 receives a read image 7 (S32), the layout analyzing unit 201 extracts the object information 60 of the object 6 to be read included in the read image 7 (S33) and stores the extracted object information 60 in the area information table 211 of the storage section 21 in association with the position information of the area corresponding to the object information 60 (S34), and the separation processing unit 202 cuts out the first rectangular area 61 (S35).

Next, the transformation unit 203 obtains the size of the first rectangular area 61, obtains the size of the object 6 to be read from the size information 212 stored in the storage section 21, and compares the size of the first rectangular area 61 with the size of the object 6 to be read (S36). In a case where the size of the first rectangular area 61 is larger than the size of the object 6 to be read (S36: Yes), the transformation unit 203 reduces the first rectangular area 61 to the second rectangular area 62 such that the object information 60 is not divided (S37).

Next, the transformation unit 203 obtains the size of a third rectangular area 63 obtained by excluding the second rectangular area 62 from the first rectangular area 61 before reduction, and compares the size of the third rectangular area 63 with the size of the object 6 to be read (S38). In a case where the size of the third rectangular area 63 is larger than the size of the object 6 to be read (S38: Yes), the transformation unit 203 further reduces the third rectangular area 63 to the fourth rectangular area 64 such that the object information 60 is not divided (S39).

The transformation unit 203 repeats the operations of the above-described steps S38 and S39 until the size of the (2×K+5)-th rectangular area becomes substantially equal to or less than the size of the object 6 to be read. That is, the transformation unit 203 obtains the size of the (2×K+5)-th rectangular area obtained by excluding the (2×K+4)-th rectangular area 62 from the (2×K+3)-th rectangular area 61 before reduction (S40), and in a case where this size is larger than the size of the object 6 to be read (S40: Yes), the transformation unit 203 further reduces the (2×K+5)-th rectangular area 61 to the (2×K+6)-th rectangular area 64 so as not to divide the object information 60 (S41). Note that K is an integer of 0 or more.

Next, the inclination correcting unit 204 performs skew correction of the second rectangular area, the fourth rectangular area, . . . , the (2×M+4)-th rectangular area, and the (2×M+5)-th rectangular area (S42), and the display control unit 205 performs control so as to separate and display the second rectangular area, the fourth rectangular area, the (2×M+4)-th rectangular area, and the (2×M+5)-th rectangular area after skew correction, on the display surface of the operation display section 23 (S43). In addition, M=0, 1, 2, . . . , and K. K is the number of times the steps S40 and S41 have been performed.

As described above, even in a case where plural objects 6 to be read are included in the first rectangular area 61, it is possible to cut out and recognize the respective objects 6 to be read individually.

### Modification Example 2

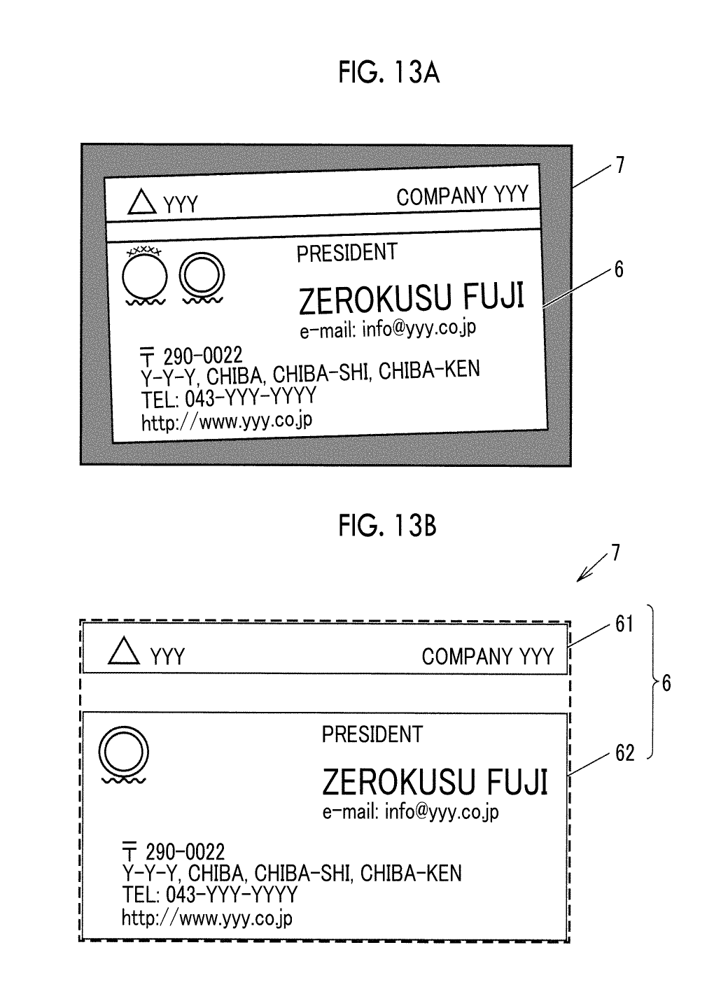

FIGS. 13A and 13B are diagrams showing examples of the read image 7. As shown in FIG. 13B, the object 6 to be read shown in FIG. 13A is divided into a first rectangular area 61 and a second rectangular area 62 and cut out.

In such a case, the changing unit changes the first rectangular area 61 such that an area having a background color different from the color of the background (hereinafter also simply referred to as “background color”) of the read image 7 is included. Here, the background means a portion of the read image 7 other than the object 6 to be read. The changing unit may change the second rectangular area 62 so as to include the area having the background color. Further, in the example shown in FIG. 13B, the case where the object 6 to be read is divided into two partial areas has been described as an example. However, even in the case where the object 6 to be read is divided into three or more partial areas, processing may be similarly performed.

By doing as described above, it is possible to recognize the entire object to be read even in a case where the object to be read is divided and cut out.

Although the exemplary embodiments of the present invention have been described above, the exemplary embodiments of the present invention are not limited to the above exemplary embodiments, and various modifications and implementations are possible within the scope not changing the gist of the present invention. For example, the size information 212 may be set for each object 6 to be read according to the operation of the user.

Further, for example, in the above-described exemplary embodiments, the configuration in which the information processing apparatus 2 includes the image reading section 24 has been described as an example, but the image reading section is not indispensable, and the information processing apparatus 2 may receive and process the read image 7 read by an external device such as the terminal device 3 described above, for example. Further, the order of the layout analysis by the layout analyzing unit 201 and the cutting process of the first area by the separation processing unit 202 may be changed.

Some units provided in the control section 20 of the information processing apparatus 2 may be moved to a control section (not shown) of the server device, and various types of data stored in the storage section 21 of the information processing apparatus 2 may be stored in a storage section (not shown) of the server device. In other words, the server apparatus may be responsible for processing the read image 7 described above. In addition, the result of processing of the read image 7, that is, the object 6 to be read cut out individually may be displayed on the display section (not shown) of the terminal device 3 instead of the operation display section 23 of the information processing apparatus 2.

Parts or all of the units the control section 20 may be configured with hardware circuits such as a field programmable gate array (FPGA) and an application specific integrated circuit (ASIC).

Further, it is possible to omit or modify a part of the constituent elements of the above exemplary embodiments within the scope not changing the gist of the present invention. Further, steps can be added, deleted, changed, and exchanged in the flow of the above exemplary embodiment within the scope not changing the gist of the present invention. The program used in the above exemplary embodiments maybe provided by being recorded in a computer readable recording medium such as a CD-ROM, or may be stored in an external server such as a cloud server and used through a network.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
an extraction unit that extracts object information from an image including an object to be read having a predetermined size;
a cutting unit that cuts out a first area including at least a part of the object to be read from the image; and
a changing unit that changes the first area such that an area having a background color different from a background color of the image is included, from the first area, when the first area cut out by the cutting unit has a size different from the predetermined size.

2. The information processing apparatus according to claim 1,
wherein the changing unit changes the first area such that the object information is included, with the first area as a base point.

3. The information processing apparatus according to claim 1,
wherein the changing unit expands the first area such that the object information is included, with the first area as a base point, when the first area has a size smaller than the predetermined size.

4. The information processing apparatus according to claim 2,
wherein the changing unit expands the first area such that the object information is included, with the first area as a base point, when the first area has a size smaller than the predetermined size.

5. The information processing apparatus according to claim 3,
wherein in a case where the image includes a plurality of the objects to be read,
the cutting unit cuts out a plurality of the first areas for each of the plurality of objects to be read, and
when some of the plurality of first areas have sizes different from the predetermined size, the changing unit respectively expands the some of the plurality of first areas such that areas respectively expanded from the some of the plurality of first areas do not overlap each other.

6. The information processing apparatus according to claim 4,
wherein in a case where the image includes a plurality of the objects to be read,
the cutting unit cuts out a plurality of the first areas for each of the plurality of objects to be read, and
when some of the plurality of first areas have sizes different from the predetermined size, the changing unit respectively expands the some of the plurality of first areas such that areas respectively expanded from the some of the plurality of first areas do not overlap each other.

7. The information processing apparatus according to claim 5,
wherein the changing unit respectively expands the some of the plurality of first areas such that the object information, which is located in a predetermined direction with respect to each of the some of the plurality of first areas in the image, is included.

8. The information processing apparatus according to claim 6,
wherein the changing unit respectively expands the some of the plurality of first areas such that the object information, which is located in a predetermined direction with respect to each of the some of the plurality of first areas in the image, is included.

9. The information processing apparatus according to claim 1,
wherein the changing unit reduces the first area to a second area such that the object information is included, with the first area as a base point, when the first area has a size larger than the predetermined size.

10. The information processing apparatus according to claim 2,
wherein the changing unit reduces the first area to a second area such that the object information is included, with the first area as a base point, when the first area has a size larger than the predetermined size.

11. The information processing apparatus according to claim 3,
wherein the changing unit reduces the first area to a second area such that the object information is included, with the first area as a base point, when the first area has a size larger than the predetermined size.

12. The information processing apparatus according to claim 4,
wherein the changing unit reduces the first area to a second area such that the object information is included, with the first area as a base point, when the first area has a size larger than the predetermined size.

13. The information processing apparatus according to claim 5,
wherein the changing unit reduces the first area to a second area such that the object information is included, with the first area as a base point, when the first area has a size larger than the predetermined size.

14. The information processing apparatus according to claim 6,
wherein the changing unit reduces the first area to a second area such that the object information is included, with the first area as a base point, when the first area has a size larger than the predetermined size.

15. The information processing apparatus according to claim 7,
wherein the changing unit reduces the first area to a second area such that the object information is included, with the first area as a base point, when the first area has a size larger than the predetermined size.

16. The information processing apparatus according to claim 8,
wherein the changing unit reduces the first area to a second area such that the object information is included, with the first area as a base point, when the first area has a size larger than the predetermined size.

17. The information processing apparatus according to claim 9,
wherein the changing unit reduces the third area to a fourth area such that the object information is included, with the third area as a base point, when a third area obtained by excluding the second area from the first area before the reduction has a size larger than the predetermined size.

18. The information processing apparatus according to claim 10,
wherein the changing unit reduces the third area to a fourth area such that the object information is included, with the third area as a base point, when a third area obtained by excluding the second area from the first area before the reduction has a size larger than the predetermined size.

19. The information processing apparatus according to claim 11,
wherein the changing unit reduces the third area to a fourth area such that the object information is included, with the third area as a base point, when a third area obtained by excluding the second area from the first area before the reduction has a size larger than the predetermined size.

20. A non-transitory computer readable medium storing a program causing a computer to function as:
an extraction unit that extracts object information from an image including an object to be read having a predetermined size;
a cutting unit that cuts out a first area including at least a part of the object to be read from the image; and
a changing unit that changes the first area such that an area having a background color different from a background color of the image is included, from the first area, when the first area cut out by the cutting unit has a size different from the predetermined size.
